(19) United States
(12) Patent Application Publication
(10) Pub. No.: US 2025/0276588 A1
(43) Pub. Date: Sep. 4, 2025

(54) ENERGY MANAGEMENT SYSTEMS FOR EXTREME FAST-CHARGING SYSTEMS, AND ASSOCIATED METHODS

(71) Applicant: Edison Technologies Inc., Las Vegas, NV (US)

(72) Inventors: Joseph H. Armstrong, Greeley, CO (US); Kong Hian Lee, Las Vegas, NV (US)

(21) Appl. No.: 19/065,176

(22) Filed: Feb. 27, 2025

Related U.S. Application Data
(60) Provisional application No. 63/559,831, filed on Feb. 29, 2024.

(51) Int. Cl. B60L 53/10; B60L 53/51; B60L 53/53; B60L 53/64; B60L 53/67; G06Q 10/0631; G06Q 50/06; H02J 3/00; H02J 3/38

(52) U.S. Cl. CPC B60L 53/11; B60L 53/51; B60L 53/53; B60L 53/64; B60L 53/67; G06Q 10/0631; G06Q 50/06; H02J 3/003; H02J 3/004; H02J 3/381; B60L 2210/10; H02J 2300/24; H02J 2300/28

(57) ABSTRACT

A method implemented by an energy management system (EMS) to optimize energy distribution in an extreme fast-charging (XFC) system includes (1) generating temporal maps for each of a plurality of energy sources, including projected capacity and energy cost over time, (2) generating a temporal map of projected load of one or more EV chargers within the XFC system, and (3) selecting one or more of the energy sources to supply energy to the XFC system over a predetermined time period based on cost, availability, and demand forecasts. This selection, for example, dynamically balances energy costs, ensures charging reliability, and/or optimizes the XFC system to support high-power charging with minimal operational expenses.

### RELATED APPLICATIONS

This application claims benefit of U.S. Provisional Patent Application No. 63/559,831, filed on Feb. 29, 2024, which is incorporated herein by reference.

### BACKGROUND

Charging of electric vehicles (EVs) in the United States can be broken down into three categories, or Levels. Level 1 charging is the lowest charging level as it utilizes household wiring (which is typically a 120-volt alternating current (VAC) single-phase circuit) and can account for 2.5 to 5 miles per one hour of charge. As Level 1 charging uses common household wiring, it can be considered a baseline, emergency charging method. Level 2 charging involves a 220 VAC to 240 VAC single phase circuit, commonly associated with an electric range or a clothes dryer, and accounts for a dramatic increase in charging rate over Level 1 charging, effectively increasing the range to 30-40 miles per one hour of charge. Another advantage of Level 2 charging is that requisite supporting circuits can be frequently accommodated both at homes and businesses. As such, Level 2 charging infrastructure is becoming popular at hotels, apartments, and other locations where charging is not time sensitive. Level 3 charging, commonly referred to as DC Fast Charging that is rated at 50 kW or higher, involves a higher level of electrical service, typically a three-phase circuit that is commonplace in businesses and factories, but is not available in residential applications. These three-phase circuits are commonly 208 VAC or 480 VAC and can account for 60-80 miles of range in only 20 minutes of charging. Level 3 charging can include what has recently begun to be referred to as extreme fast-charging (XFC) that requires an EV capable of accepting over 300 kW of direct current (DC) power and usually is indicative of EV battery packs being rated at 800 volts direct current (VDC) or above. With XFC, it is possible for an EV to charge from 10 percent to 80 percent capacity in under 10 minutes, or effectively close to the equivalent duration of an internal combustion engine (ICE) vehicle refueling experience. EV charging categories may vary in other countries, but differences in EV charging speed between categories are analogous to those in the United States.

### SUMMARY

Disclosed herein are energy management systems (EMSs) and associated methods which will provide an autonomous and predictive means for operating an electric vehicle (EV) charging station, such as an extreme fast-charging (XFC) EV charging station. Certain embodiments of the new EMSs employ energy arbitrage to select a most economical electric energy source from two or more electric energy sources, such as an electric power grid and a photovoltaic energy source, to charge one or more battery energy storage systems (BESSs), including of one or more batteries, of an EV charging station while ensuring that sufficient energy is available to meet EV charging station needs. For example, some embodiments of new EMSs may select a combination of electric energy sources for charging the BESSs over a particular time frame, e.g., over a particular 24-hour period, to ensure that a sufficient amount of energy is stored in the BESSs to cover anticipated loads associated with charging EVs during the time frame. Additionally, these embodiments may select among the electric energy sources to ensure that the energy stored in the BESSs is obtained at a lowest feasible cost. Certain embodiments employ stochastic programming techniques, statistical inference, and estimation methods applied to historical and real-time data on traffic patterns and an established base case of power flow from the utility to determine projected electric energy source capacity, forecast projected electric energy source costs, predict projected EV charger load, and/or optimize selection of electric energy sources based on probabilistic modeling and optimization principles.

In an embodiment, a method operable by an EMS for operating an XFC system includes (1) generating respective temporal maps of projected capacity of a plurality of electric energy sources, (2) generating respective temporal maps of projected energy cost of the plurality of electric energy sources, (3) generating a temporal map of projected load of one or more electric vehicle chargers of the extreme fast-charging system, and (4) selecting one or more of the plurality of electric energy sources to provide energy to the extreme fast-charging system over a predetermined time period at least partially based on (a) the respective temporal maps of projected capacity of the plurality of electric energy sources, (b) the respective temporal maps of projected energy cost of the plurality of electric energy sources, and (c) the temporal map of projected load of the one or more electric vehicle chargers of the extreme fast-charging system, to provide sufficient energy for meeting the projected load of the one or more electric vehicle chargers of the extreme fast-charging system while complying with at least one additional objective.

In an embodiment, a method operable by an EMS for operating an XFC system includes (1) selecting a renewable electric energy source to charge a BESS of the extreme fast-charging system during a first time period, (2) obtaining first information indicating a projected decrease in capacity of the renewable electric energy source during a third time period that is after the first time period, and (3) in response to obtaining the first information, selecting an electric power grid energy source to charge the BESS during a second time period that is after the first time period but is before the third time period, to compensate for the projected decrease in capacity of the renewable electric energy source during the third time period.

### BRIEF DESCRIPTION OF THE DRAWINGS

FIG. 1 is a schematic diagram of an electrical environment including an energy management system (EMS), according to an embodiment.

FIG. 2 is a schematic diagram of one possible embodiment of a controller of the FIG. 1 electrical environment.

FIG. 3 is a schematic diagram of another possible embodiment of the controller of the FIG. 1 electrical environment.

FIG. 4 is a schematic diagram of control logic of one embodiment of the EMS of FIG. 1.

FIG. 5 is a block diagram illustrating one possible implementation of the FIG. 4 EMS.

FIG. 6 is a schematic diagram of control logic of one embodiment of a load projection module of the FIG. 4 EMS.

FIG. 7 is a schematic diagram of control logic of one embodiment of a renewable projection module of the FIG. 4 EMS.

FIG. 8 is a schematic diagram of control logic of one embodiment of a grid projection module of the FIG. 4 EMS.

FIG. 9 illustrates one example of operation of the FIG. 4 EMS.

FIG. 10 is a flow chart of a method operable by an EMS for operating an extreme fast-charging (XFC) system, according to an embodiment.

FIG. 11 is a flow chart of another method operable by an EMS for operating an XFC system, according to an embodiment.

### DETAILED DESCRIPTION OF THE EMBODIMENTS

While extreme fast-charging (XFC) has significant benefits, XFC requires delivery of a large amount of energy to an electric vehicle (EV) in a short amount of time. As such, XFC requires a high-capacity electric power source. For example, an XFC system must be capable of providing approximately 360 kilowatts of power to an EV to achieve EV charging times that are comparable to refueling times of internal combustion engine (ICE) vehicles. Such a requirement for a high-capacity electric power source is particularly acute in EV charging stations including multiple EV chargers where multiple vehicles may simultaneously undergo XFC.

EV charging stations are conventionally powered by an electric power grid, such as by an electric power grid operated by an electric utility. Electric power purchased from an electric power grid may be costly, especially during times of peak electric power demand, as electric utilities are increasingly implementing variable, e.g., time-of-day, pricing for electric energy. Additionally, while electric power grids are conventionally considered reliable electric energy sources, available electric power grid capacity may significantly vary, such as according to current load on the electric power grid, rolling brownouts, unplanned brownouts, etc. As such, an EV charging station powered solely from an electric power grid typically has high operating costs and may be incapable of supporting simultaneous XFC of multiple EVs.

A renewable electric energy source, such as a photovoltaic energy source or a wind turbine energy source, may supplement an electric power grid at an EV charging station. However, capacity of renewable energy sources may significantly vary. For example, photovoltaic energy source capacity varies by time of day, sunlight obscuration by clouds, precipitation, airborne particulates, temperature, and humidity. As such, conventional use of a renewable electric energy source to supplement an electric power grid at an EV charging station leaves the EV charging station dependent on a costly, and potentially unreliable, electric power grid for significant durations. For example, consider an EV charging station that is primarily powered from an electric power grid and includes a photovoltaic energy source for supplemental electric power. The EV charging station will be completely dependent on the electric power grid at times when the photovoltaic energy source is not producing electric power, such as at night and on days when the photovoltaic energy source is covered by snow.

Disclosed herein are energy management systems (EMSs) and associated methods which at least partially overcome the above-discussed problems by providing an autonomous and predictive means for operating an EV charging station. Certain embodiments of the new EMSs employ energy arbitrage to select a most economical electric energy source from two or more electric energy sources, such as an electric power grid and a photovoltaic energy source, to charge one or more battery energy storage systems (BESSs) of an EV charging station while ensuring that sufficient energy is available to meet EV charging station needs. For example, some embodiments of new EMSs may select a combination of electric energy sources for charging the BESSs over a particular time frame, e.g., over a particular 24-hour period, to ensure that a sufficient amount of energy is stored in the BESSs to cover anticipated loads associated with charging EVs during the time frame. Additionally, these embodiments may select among the electric energy sources to ensure that the energy stored in the BESSs is obtained at a lowest feasible cost. Energy cost may be calculated by the EMSs and/or obtained from an external source accessible to the EMSs. For example, the cost of producing energy via a renewable energy source may be calculated, and the cost of energy from an electric power grid may be obtained from an external information source.

Many variations in electric energy source capacity and/or cost are due to cyclic changes, such as seasons, and other variations can be predicted a day or two in advance, such as by weather modeling. Particular embodiments of the new EMSs generate a plurality of temporal maps, such as maps representing the capacity of each electric energy source as a function of time, the cost of each electric energy source as a function of time, and the consumption of an EV station as a function of time, for both present operation and near-term future operation. These EMS embodiments then compare the maps to determine a most cost-effective selection of electric energy sources for charging one or more BESSs of the EV station, as well as to ensure that the BESSs will be sufficiently charged to meet anticipated electric power demand of the EV station. For example, in some embodiments, a temporal map of predicted consumption is overlaid with a temporal map of electric energy source capacity to ensure that there is sufficient electric energy source capacity to meet projected EV station load, and low-cost electric energy sources (e.g., renewable energy sources) of the available electric energy sources are selected to meet the projected load before selecting high-cost electric energy sources (e.g., an electric power grid). In certain embodiments, any projected shortfall in renewable energy source capacity over a particular time frame (e.g., over a particular 24-hour period) is compensated by (i) purchasing energy from an electric power grid at times when electric power grid rates are low and (ii) storing the purchased energy in one or more BESSs for use in powering the EV charging station over the particular time frame.

Furthermore, certain embodiments of the new EMSs are configured to determine trends in individual EV charging, as well as trends in collective EV charging, such as by (i) analyzing data of historical EV charging station operation and/or (ii) data obtained from EVs being charged, e.g., via datalinks between the EVs and EV chargers. The new EMSs may be configured to use these trends to estimate impacts of holidays, and other events, on estimated EV station consumption for a given time frame. Certain embodiments of the new EMSs use just-in-time prediction algorithms based on recent hours of operational data and historically established patterns to prioritize available energy storage within a BESS, account for the real-time status of charging stations and anticipated hours of EV station charging, and dynamically adjust the rate of solar power harvest while managing supplemental energy injection from the electrical utility. These methods facilitate the estimation of load demands of EV charging, electric energy source capacity, electric energy source costs, and/or the optimal selection of electric energy sources based on real-time and historical data-driven decision-making.

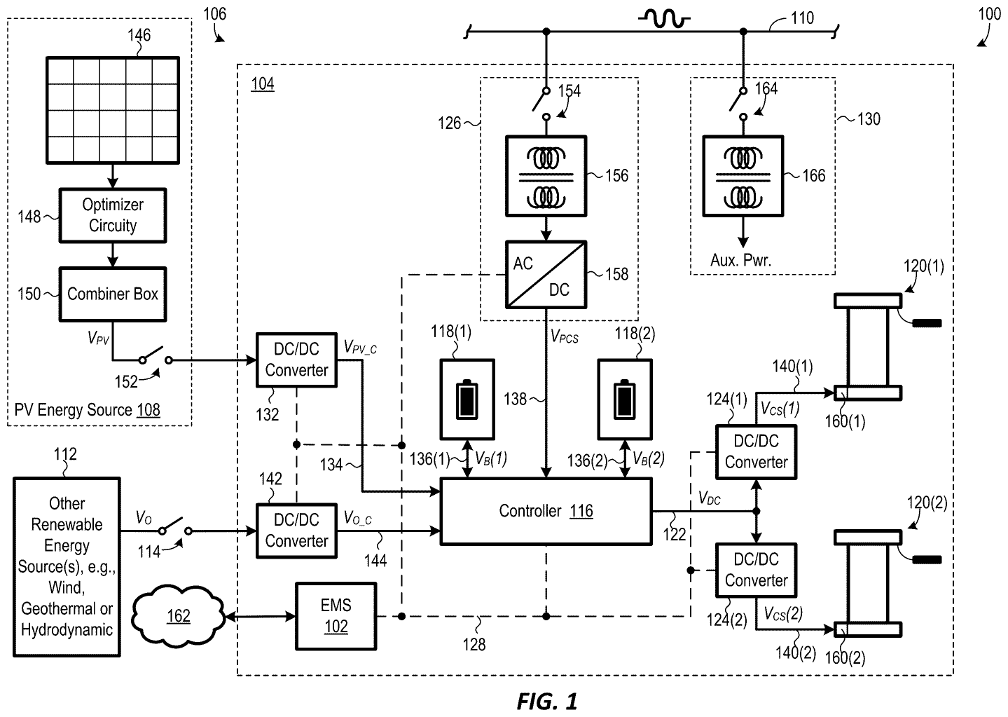

FIG. 1 is a schematic diagram of an electrical environment 100 including an EMS 102, where EMS 102 is one embodiment on the new EMSs disclosed herein. EMS 102 is part of an XFC system 104, which is implemented at an EV charging station 106. It is understood, though, that EMS 102 could be used in other charging systems, including charging systems that are not capable of XFC. Additionally, EMS 102 could be separate from, but communicatively coupled to, XFC system 104 without departing from the scope hereof. Electrical environment 100 further includes a photovoltaic (PV) energy source 108 and an AC electric power grid 110. Electrical environment 100 optionally also includes one or more other renewable energy sources 112 and an associated power disconnect switch 114. While PV energy source 108, other renewable energy sources 112, and power disconnect switch 114 are depicted as being separate from XFC system 104, in some alternate embodiments, one or more of these elements are partially or fully incorporated with XFC system 104. For example, in some alternate embodiments, PV energy source 108 is incorporated with XFC system 104, such as when PV energy source 108 is physically located at EV charging station 106.

XFC system 104 includes, in addition to EMS 102, a controller 116, BESSs 118, EV chargers 120, a main DC electric power bus 122, a respective DC/DC converter 124 for each EV charger 120, an AC energy source 126, a low-voltage data control line 128, an auxiliary power system 130, a DC/DC converter 132, a DC electric power bus 134, a respective DC electric power bus 136 for each BESS 118, a DC electric power bus 138, and a respective DC electric power bus 140 for each EV charger 120. In this document, specific instances of an item may be referred to by use of a numeral in parentheses (e.g., BESS 118(1)) while numerals without parentheses refer to any such item (e.g. BESSs 118). XFC system 104 optionally further includes a DC/DC converter 142 and a DC electric power bus 144 associated with other renewable energy sources 112. While XFC system 104 is depicted as including two BESSs 118, the quantity of BESSs 118 of XFC system 104 may vary. Additionally, although XFC system 104 is depicted as including two EV chargers 120, the quantity of EV chargers 120 may also vary.

XFC system 104 is designed to utilize state-of-the-art and future battery technologies capable of reaching significant charge capacity in a short amount of time, a feature that is in significant demand within the emerging EV market. For example, as discussed below, in particular embodiments, EMS 102 is configured to control XFC system 104 to ensure that power provided to an EV is the most economical to the consumer by using renewable energy, e.g., PV energy source 108 and/or other renewable energy sources 112, as a primary energy source and only using AC energy source 126 as a backup electric energy source, and by ensuring that system losses by unnecessary rectification/inverting functions are eliminated. Thus, in certain embodiments, the bulk of XFC system 104 consists of DC electric power buses, with AC energy source 126 providing electric energy as a backup only. However, it is understood that XFC system 104 could be modified to include additional elements without departing from the scope hereof.

PV energy source 108 includes a PV array 146, optimizer circuitry 148, a combiner box 150, and a power disconnect switch 152. In one embodiment, PV array 146 is sized to provide sufficient electric power to XFC system 104, e.g., to meet anticipated demand of EV chargers 120. Output of PV array 146 is optimized by optimizer circuitry 148 that includes a maximum peak power tracker (MPPT), sometimes alternately referred to as a maximum power point tracker, and associated circuitry, to help ensure maximum PV array 146 output by adjusting its input impedance such that PV array 146 operates at its maximum power point. Combiner box 150 is used to obtain a single power lead from PV energy source 108 into XFC system 104, such as by combining electrical outputs of one or more optional additional PV arrays (not shown) with the output of PV array 146. Combiner box 150 is electrically coupled to DC/DC converter 132 by power disconnect switch 152. The configuration of PV energy source 108 may vary as long as it is capable of providing DC electric power to XFC system 104. Additionally, some functionality of PV energy source 108 may be incorporated in XFC system 104. For example, in particular alternate embodiments, DC/DC converter 132 can perform MPPT and optimizer circuitry 148 is therefore omitted.

Electric power provided by PV energy source 108 can be energized and de-energized by power disconnect switch 152. When power disconnect switch 152 is closed, electric power generated by PV energy source 108 goes through a high-efficiency DC/DC converter 132 to match its voltage output to that necessary to power XFC system 104. Specifically, DC/DC converter 132 converts a voltage magnitude V_{PV} of electric power generated by PV array 146 to a voltage magnitude V_{PV_C} on DC electric power bus 134, where DC electric power bus 134 electrically couples DC/DC converter 132 to controller 116. DC/DC converter 132 is optional if voltage magnitude V_{PV} is already matched to XFC system 104. Other renewable energy sources 112 can also be incorporated to provide the necessary power to XFC system 104. Other renewable energy sources 112 can include, but are not limited to, wind, geothermal, and hydrodynamic electric energy sources, provided that this power is predominantly DC (or is converted to DC before reaching XFC system 104). Similar to PV energy source 108, energizing and de-energizing other renewable energy sources 112 goes through a power disconnect switch 114 and then through DC/DC converter 142 to match the necessary voltage of XFC system 104. Specifically, DC/DC converter 142 converts a voltage magnitude V_{O} of electric power generated by other renewable energy sources 112 to a voltage magnitude V_{O_C} on DC electric power bus 144, where DC electric power bus 144 electrically couples DC/DC converter 142 to controller 116. In some alternate embodiments, DC/DC converter 142 is omitted, such as if voltage magnitude Vo is already matched to the voltage of XFC system 104.

AC energy source 126 includes a power disconnect switch 154, an isolation transformer 156, and a power conversion system (PCS) 158. PCS 158 is electrically coupled to AC electric power grid 110 via the series combination of power disconnect switch 154 and isolation transformer 156. AC electric power grid 110 provides a backup source of electric power to XFC system 104 via AC energy source 126. Electric power from AC electric power grid 110 is likely to be more expensive than electric power from PV energy source 108 and other renewable energy sources 112, but AC electric power grid 110 may provide capacity for charging BESSs 118, or directly powering XFC system 104, when PV energy source 108 and other renewable energy sources 112 (if present) are unavailable or have insufficient capacity. After energizing/de-energizing via power disconnect switch 154, isolation transformer 156 is employed to protect AC electric power grid 110 as well as the equipment of XFC system 104 connected to AC electric power grid 110. Electric power from isolation transformer 156 is provided to PCS 158 that rectifies the AC electric power to DC electric power having a voltage magnitude V_{PCS} and is matched, for example, to the needs of BESSs 118. Accordingly, PCS 158 is powered from AC electric power grid 110 via isolation transformer 156 and power disconnect switch 154. PCS 158 is electrically coupled to controller 116 via DC electric power bus 138. In some alternate embodiments, AC electric power grid 110 is replaced with a DC power grid, and AC energy source 126 is replaced with equipment, such as a DC/DC converter, to electrically couple DC electric power bus 138 with the DC power grid.

BESSs 118 serve as DC electric energy storage systems in XFC system 104 and are capable of powering XFC system 104. Within a 24-hour cycle, BESS 118 charging options may vary depending upon conditions, as controlled by EMS 102. Each BESS 118 is electrically coupled to controller 116 via a respective DC electric power bus 136. In particular embodiments, each BESS 118 includes one or more high-capacity batteries, e.g., a Lithium-ion batteries, where each battery includes one or more electrochemical cells. For example, in certain embodiments, each BESS includes one or more strings of batteries electrically coupled in series. Each BESS 118 may include additional equipment, such as a charging controller, power conversion equipment, telemetry equipment, safety devices, climate control equipment, etc., in addition to batteries. Each BESS 118 provides DC electric power having a respective voltage magnitude VB on its respective DC electric power bus 136, where voltage magnitudes VB are designed to meet XFC system 104 requirements. BESSs 118 could be supplemented by, or replaced with, other DC energy storage systems, including but not limited to inertial flywheel storage units.

Electric power from AC electric power grid 110 via AC energy source 126, electric power from PV energy source 108, and electric power from other renewable energy sources 112, is provided to controller 116 via DC electric power buses 138, 134, and 144, respectively, and the provided electric power is available for charging BESSs 118 and/or powering EV chargers 120. Controller 116 includes, for example, one or more switching devices, such as relays, transistors, contactors, or the like (not shown), that are configured to selectively electrically couple one or more electric energy sources, e.g., PV energy source 108, other renewable energy sources 112, and/or AC energy source 126, to one or more loads, e.g., BESSs 118 and/or EV chargers 120, such as in response to signals from EMS 102. Main DC electric power bus 122 exits controller 116 and is electrically coupled to one or more EV chargers 120, each with an optional DC/DC converter 124 to match voltage magnitude V_{DC} of main DC electric power bus 122 to respective DC-only inputs 160 of EV chargers 120. Specifically, each DC/DC converter 124 is electrically coupled to controller 116 via main DC electric power bus 122, and each EV charger 120 is electrically coupled to its respective DC/DC converter 124 via its respective DC electric power bus 140. Each DC/DC converter 124 is configured to convert electric power voltage magnitude V_{DC} on main DC electric power bus 122 to a respective electric power voltage magnitude V_{CS} on its respective DC electric power bus 140.

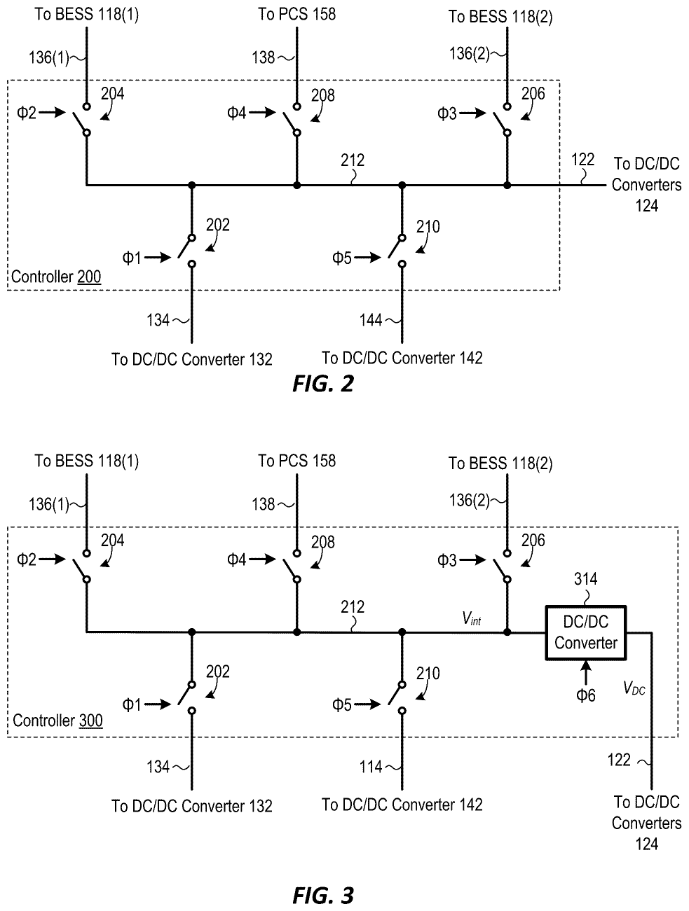

In certain embodiments, voltage magnitude V_{PV_C}, voltage magnitude V_{O_C}, voltage magnitude V_{PCS}, and voltage magnitudes V_{B} are each equal to voltage magnitude V_{DC}, such that controller 116 need not perform voltage magnitude transformation, thereby promoting high efficiency and simplicity by eliminating the need for voltage magnitude transformation in controller 116. For example, FIG. 2 is a schematic diagram of a controller 200, which is one possible embodiment of controller 116 that does not perform voltage magnitude transformation. Controller 200 includes a switching device 202, a switching device 204, a switching device 206, a switching device 208, a switching device 210, and an internal DC electric power bus 212. Each switching device 202-210 includes, for example, one or more relays, transistors, contactors, or the like. Switching device 202 is electrically coupled between DC electric power bus 134 and internal DC electric power bus 212, and switching device 202 is controlled by a control signal Φ1. Switching device 204 is electrically coupled between DC electric power bus 136(1) and internal DC electric power bus 212, and switching device 204 is controlled by a control signal Φ2. Switching device 206 is electrically coupled between DC electric power bus 136(2) and internal DC electric power bus 212, and switching device 206 is controlled by a control signal Φ3. Switching device 208 is electrically coupled between DC electric power bus 138 and internal DC electric power bus 212, and switching device 208 is controlled by a control signal Φ4. Switching device 210 is electrically coupled between DC electric power bus 144 and internal DC electric power bus 212, and switching device 210 is controlled by a control signal Φ5. Internal DC electric power bus 212 is electrically coupled to main DC electric power bus 122. EMS 102 is configured to generate control signals Φ1, Φ2, Φ3, 4, and Φ5, and low voltage data control line 128 transmits control signals Φ1, Φ2, Φ3, Φ4, and Φ5 from EMS 102 to controller 200. In some alternate embodiments, low voltage data control line 128 is replaced with, or supplemented by, other communication equipment, such as an optical communication equipment or wireless communication equipment.

EMS 102 is configured to generate control signals Φ1, Φ2, Φ3, Φ4, and Φ5 to control flow of electric power in XFC system 104. For example, EMS 104 may cause electric power from PV energy source 108 to flow to BESSs 118 and to EV chargers 120, for charging BESSs 118 and powering EV chargers 120, respectively, by generating control signals Φ1, Φ2, Φ3, Φ4, and Φ5 such that (i) each of switching devices 202, 204, and 206 is closed and (ii) each of switching devices 208 and 210 is open. As another example, EMS 102 may cause electric power from AC energy source 126 to flow to BESSs 118 and to EV chargers 120, for charging BESSs 118 and powering EV chargers 120, respectively, by generating control signals Φ1, Φ2, Φ3, Φ4, and Φ5 such that (i) each of switching devices 204, 206, and 208 is closed and (ii) each of switching devices 202 and 210 is open. As an additional example, EMS 102 may cause electric power from BESSs 118 to flow to EV chargers 120, for powering EV chargers 120 without charging BESSs 118, by generating control signals Φ1, Φ2, Φ3, Φ4, and Φ5 such that (i) each of switching devices 204 and 206 is closed and (ii) each of switching devices 202, 208, and 210 is open.

Controller 200 could be modified to support additional functionality. For example, controller 200 could be modified to include one or more additional switching devices to enable simultaneous charging of BESSs 118 from one of PV energy source 108 and AC energy source 126 while powering EV chargers 120 from the other of PV energy source 108 and AC energy source 126. As another example, controller 200 could be modified to include additional switching devices to enable simultaneous charging of BESS 118(1) and discharge of BESS 118(2) into EV chargers 120. As a further example, controller 200 could be modified to include one or more devices for performing voltage magnitude conversion. For example, FIG. 3 is a schematic diagram of a controller 300, which is one possible embodiment of controller 116 that is capable of performing voltage magnitude transformation. Controller 300 is like controller 200 except that controller 300 further includes a DC/DC converter 314 electrically coupled between internal DC electric power bus 212 and main DC electric power bus 122. DC/DC converter 314 is configured to convert electric power voltage magnitude Vᵢₙₜ on internal DC electric power bus 212 to electric power voltage magnitude V_{DC} on main DC electric power bus 122 in response to a control signal Φ6 generated by EMS 102. In some embodiments, EMS 102 is configured to control DC/DC converter 314 such that DC/DC converter 314 only operates when needed. For example, assume a hypothetical scenario where each of voltage magnitude V_{PV_C}, voltage magnitude V_{PCS}, and voltage magnitudes V_{B} is equal to voltage magnitude V_{DC}, but voltage magnitude V_{O_C} differs from voltage magnitude V_{DC}. In this scenario, EMS 102 could be configured such that (i) DC/DC converter 314 operates as a voltage conversion device when switching device 210 is closed and (ii) DC/DC converter 314 operates in a bypass mode when switching device 210 is open. The bypass mode is characterized, for example, by DC/DC converter 314 connecting internal DC electric power bus 212 to main DC electric power bus 122 without performing power conversion.

Referring again to FIG. 1, auxiliary power system 130 includes a power disconnect switch 164 and an isolation transformer 166. Auxiliary power system 130 is energized/de-energized via power disconnect switch 164, and isolation transformer 166 protects AC electric power grid 110 as well as equipment of XFC 104 connected to AC electric power grid 110. Auxiliary power system 130 may include additional elements, such as rectification circuitry (not shown) and a DC/DC converter (not shown). Auxiliary power system 130 is used, for example, when powering up XFC system 104 to provide an initial power source for elements of XFC system 104, such as EMS 102 and controller 116.

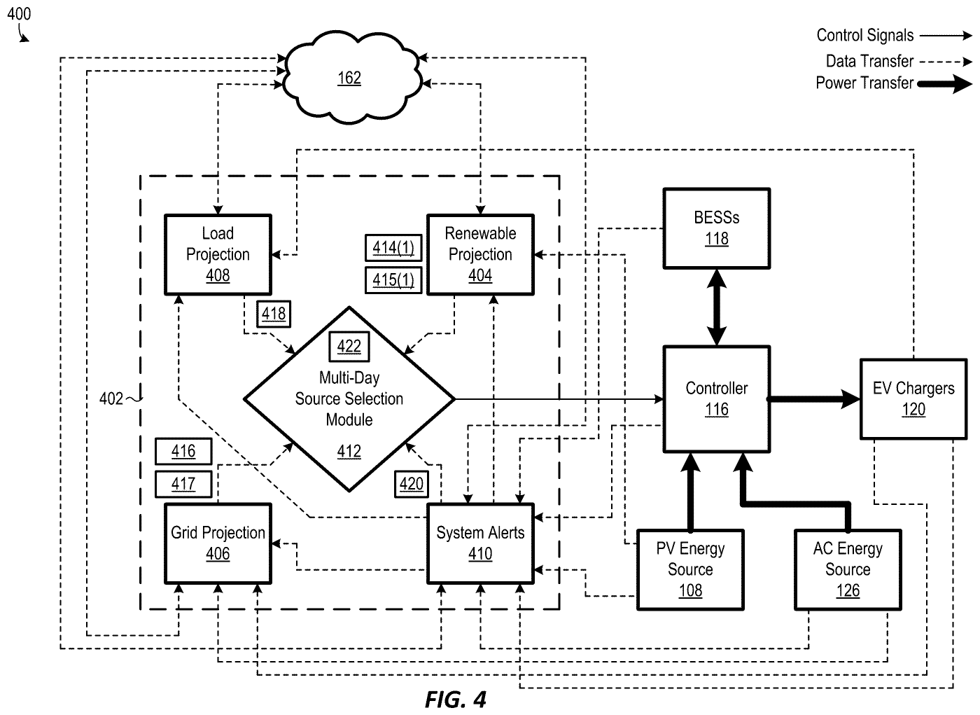

EMS 102 is configured to control operation of XFC system 104, such as by controlling operation of controller 116 to select among PV energy source 108, AC energy source 126, and other renewable energy sources 112 (if present), to provide electric power to XFC system 104, to (i) cause BESSs 118 to be charged with energy that is obtained at a lowest possible cost and (ii) ensure that sufficient energy is available to meet anticipated load of EV chargers 120. In particular embodiments, EMS 102 prioritizes use of renewable energy sources over use of non-renewable energy sources in powering XFC system 104. For example, in certain embodiments, EMS 102 is configured to control XFC system 104 such that (i) PV energy source 108 and other renewable energy sources 112 (when present) are prioritized for powering XFC system 104 and (ii) AC electric power grid 110 is used to supply any shortfall in renewable energy sources by sourcing energy from AC energy source 126 at times when (1) AC electric power grid 110 rates are low and (2) AC electric power grid 110 has sufficient capacity to charge BESSs 118 and/or directly power EV chargers 120. In some embodiments, EMS 102 controls XFC system 104 at least partially based on data from external data sources 162. FIGS. 4-9, discussed below, illustrate examples of configuration and operation of EMS 102. It is understood, however, that the configuration and operation of EMS 102 is not limited to the examples of FIGS. 4-9.

FIG. 4 is schematic diagram 400 of control logic of an EMS 402, where EMS 402 is one embodiment of EMS 102 of FIG. 1. Schematic diagram 400 further includes PV energy source 108, controller 116, BESSs 118, EV chargers 120, AC energy source 126, and external data sources 162, in addition to EMS 402. Other renewable energy sources 112 are not shown in FIG. 4 for illustrative clarity, but it is understood that other renewable energy sources 112 could be controlled by EMS 402 in a manner similar to how EMS 402 controls PV energy source 108. Control signal flow is indicated by a light arrow, data transfer is indicated by dashed arrows, and power transfer is indicated by heavy arrows, in schematic diagram 400. EMS 402 includes a renewable projection module 404, a grid projection module 406, a load projection module 408, a system alerts module 410, and a multi-day source selection module 412.

External data sources 162 include, for example, control signals from one or more servers for remote control of XFC system 104, autonomous polling or pushing of data signals from free services, and/or autonomous polling or pushing of data signals from paid services. Examples of possible data represented by signals from external data sources 162 include, but are not limited to, weather reports (reporting present weather and/or predicted weather), natural and man-made environmental conditions (present and/or predicted), traffic information, data streams from services that can monitor individual EV charging history, and/or data from AC electric power grid 110 operations, including possible sub-optimum capacity alerts or outage notifications.

Renewable projection module 404 is configured to generate (i) a respective map 414 for each renewable electric energy source (e.g., PV energy source 108 and/or other renewable energy sources 112) representing present and projected capacity of the renewable electric energy source as a function of time, and (ii) a respective map 415 for each renewable electric energy source representing present and projected cost of the renewable electric energy source as a function of time. In some alternate embodiments, capacity and cost of each renewable electric energy source are combined into a common temporal map for the renewable electric energy source. In certain embodiments, each map 414 is a data structure of capacity values as a function of time values, and each map 415 is a data structure of cost values as a function of time values. FIG. 4 assumes that other renewable energy sources 112 are omitted, and FIG. 4 therefore only shows two maps being generated by renewable projection module 404, i.e., a map 414(1) representing present and projected capacity of PV energy source 108 and a map 415(1) representing present and projected cost of PV energy source 108.

Grid projection module 406 is configured to generate (i) a map 416 representing present and projected capacity of AC electric power grid 110 as a function of time and (ii) a map 417 representing present and projected cost of energy purchased from AC electric power grid 110 as a function of time. In some embodiments, map 416 is a data structure of capacity values as a function of time values, and map 417 is a data structure of cost values as a function of time values. Load projection module 408 is configured to generate a map 418 of present and projected load of EV chargers 120 as a function of time. In some embodiments, map 418 is data structure of load values as a function of time values. Load projection module 408 is optionally also configured to generate a map (not shown) of present and projected cost associated with load of EV chargers 120 as a function of time.

System alerts module 410, in turn, is configured to generate system alerts 420 for multi-day source selection module 412. System alerts 420 are used by multi-day source selection module 412, for example, to alter priority of electric energy source selection in response to one more conditions internal to XFC system 104 and/or conditions external to XFC system 104. For example, system alerts 420 may reflect health of XFC system 104, and EMS 402 may consider health of XFC system 104 when determining electric energy source priority selection.

Maps 414, maps 415, map 416, map 417, map 418, and system alerts 420 are fed into multi-day source selection module 412, and multi-day source selection module 412 generates one or more selection maps 422 based on these items. For example, multi-day source selection module 412 may overlay maps 414, maps 415, map 416, map 417, map 418 to find a lowest-cost selection of electric energy sources that meets the projected load of map 418, and multi-day source selection module 412 may generate one or more selection maps 422 indicating the lowest-cost selection. As another example, multi-day source selection module 412 may provide map 414, map 415, map 416, map 417, map 418 to a correlation inference engine, which determines a lowest-cost selection of electric energy sources that meets the projected load of map 418. The multi-day source selection module 412 may then generate one or more selection maps 422 indicating the lowest-cost selection. Selection maps 422 include, for example, a map that specifies how XFC system 104 is to be powered, as a function of time for the present and near-term future. For example, in certain embodiments, one or more selection maps 422 indicate (i) what energy source, if any, charges BESSs 118 as a function of time, and (ii) how EV chargers 120 are powered, e.g., by one or more BESSs and/or by one or more energy sources, as a function of time.

EMS 402 uses selection maps 422 to specify selected energy sources for charging BESSs 118 and/or directly powering EV chargers 120 at a lowest feasible cost, while ensuring that adequate energy is available to meet present and predicted consumption of EV chargers 120. EMS 402 selects an electric energy source for charging BESSs 118 by controlling controller 116 to electrically couple the electric energy source to BESSs 118. For example, in embodiments where controller 116 is embodied by controller 200 of FIG. 2, EMS 402 selects PV energy source 108 for charging BESS 118(1) by causing switching devices 202 and 204 to be closed, thereby electrically coupling PV energy source 108 to BESS 118(1). As another example, EMS 402 selects AC energy source 126 for charging BESS 118(2) by causing switching devices 206 and 208 to be closed, thereby electrically coupling AC energy source 126 to BESS 118(2). As a further example, EMS 402 selects BESS 118(1) to power EV chargers 120 by causing switching device 204 to be closed, thereby electrically coupling BESS 118(1) to EV chargers 120. As an additional example, EMS 402 selects PV energy source 108 for directly powering EV chargers 120 by causing switching device 202 to be closed, thereby electrically coupling PV energy source 108 to EV chargers 120.

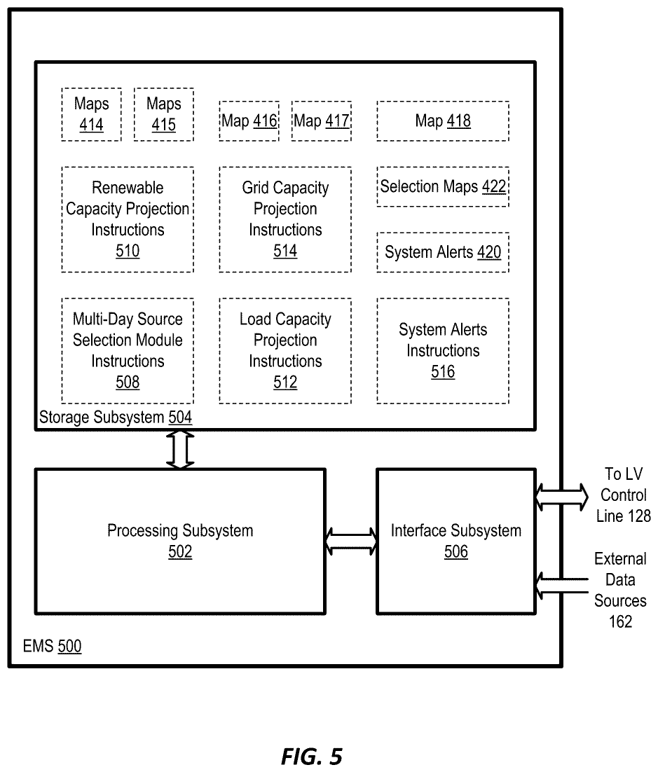

In some embodiments, each of renewable projection module 404, grid projection module 406, load projection module 408, system alerts module 410, and multi-day source selection module 412 is implemented by analog and/or digital electronic circuitry. For example, FIG. 5 is block diagram of an EMS 500, where EMS 500 is one possible embodiment of EMS 402. EMS 500 includes a processing subsystem 502, a storage subsystem 504, and an interface subsystem 506. Processing subsystem 502 is communicatively coupled to each of storage subsystem 504 and interface subsystem 506. Although processing subsystem 502, storage subsystem 504, and interface subsystem 506 are depicted as being different respective elements, each of these elements could be embodied by two or more sub elements that need not be collocated. For example, one or more of processing subsystem 502 and storage subsystem 504 could be at least partially embodied by a distributed computing system, such as a cloud computing system. Additionally, two or more of processing subsystem 502, storage subsystem 504, and interface subsystem 506 could be partially or fully combined. Interface subsystem 506 provides an interface between EMS 500 and external elements. For example, low voltage data control line 128 is communicatively coupled to EMS 500 via interface subsystem 506, and EMS 500 is communicatively coupled to external data sources 162 via interface subsystem 506.

Storage subsystem 504 stores information, such as instructions and/or data, for use by EMS 500. For example, processing subsystem 502 is depicted as storing multi-day source selection module instructions 508, renewable capacity projection instructions 510, load capacity projection instructions 512, grid capacity projection instructions 514, system alert instructions 516, maps 414, maps 415, map 416, map 417, map 418, system alerts 420, one or more selection maps 422. Processing subsystem 502 is configured to execute multi-day source selection module instructions 508, renewable capacity projection instructions 510, load capacity projection instructions 512, grid capacity projection instructions 514, and system alert instructions 516 to implement multi-day source selection module 412, renewable projection module 404, load projection module 408, grid projection module 406, and system alerts module 410, respectively.

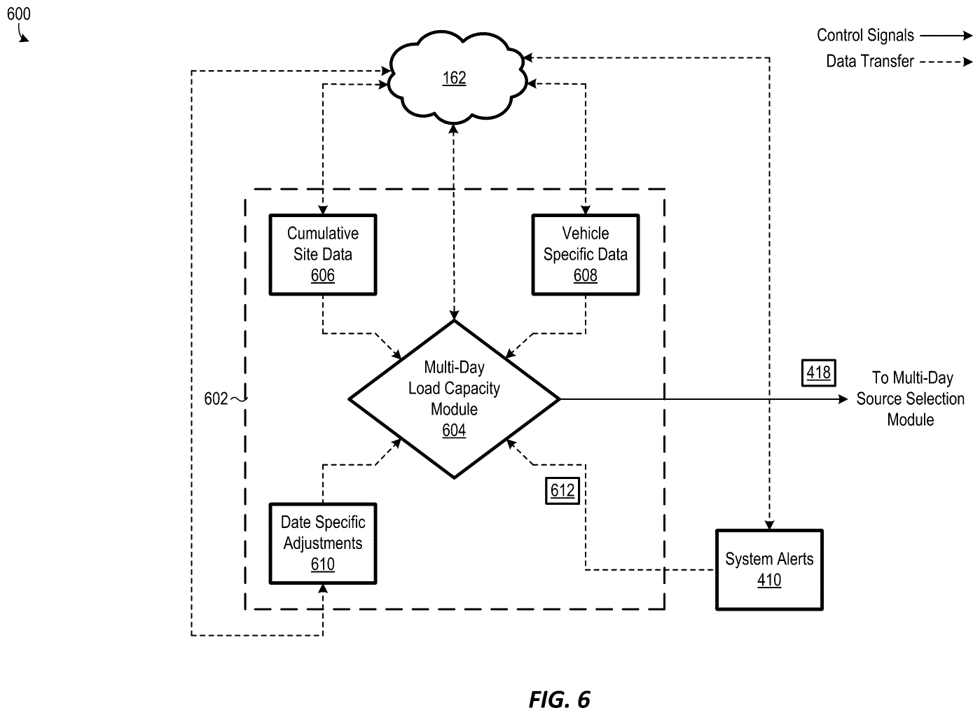

FIG. 6 is a schematic diagram 600 of control logic of a load projection module 602, where load projection module 602 is one embodiment of load projection module 408 of FIG. 4. Schematic diagram 600 includes system alerts module 410 and external data sources 162, in addition to load projection module 602. Control signal flow is indicated by a light arrow, and data transfer is indicated by dashed arrows, in schematic diagram 600. Load projection module 602 includes a multi-day load capacity module 604, cumulative site data 606, vehicle specific data 608, and date specific adjustments 610. In some embodiments, multi-day load capacity module 604 is implemented by analog and/or digital electronic circuitry. For example, in certain embodiments, multi-day load capacity module 604 is at least partially implemented by processing subsystem 502 of FIG. 5 executing load capacity projection instructions 512 of FIG. 5. Additionally, in some embodiments, cumulative site data 606, vehicle specific data 608, and date specific adjustments 610 are stored in storage subsystem 504 of FIG. 5.

Multi-day load capacity module 604 is configured to generate map 418 from cumulative site data 606, vehicle specific data 608, date specific adjustments 610, external data sources 162, and system alerts 612 from system alerts module 410. Map 418 represents, for example, several days of predicted load of EV chargers 120 from the present to the near future. Multi-day load capacity module 604 uses cumulative site data 606, for example, to help ensure that map 418 reflects load history of EV chargers 120. In particular embodiments of load projection module 602, data from external data sources 162 is combined with cumulative site data 606 that represents data that is collected about the performance of a specific location (e.g., location of EV charging station 106), such as traffic patterns in the vicinity of the location, to ultimately provide year-to-year data to improve predictive accuracy. Cumulative site data 606 may be collected locally from EV charging station 106. Additionally or alternately, cumulative site data 606 may be remotely collected and stored until needed.

Multi-day load capacity module 604 uses vehicle specific data 608, for example, to further tailor projected load of EV chargers 120 to information provided by vehicles being charged by XFC system 104. EV chargers 120 obtain vehicle specific data 608 from EVs via Wi-Fi, Bluetooth, or another communication means, during EV charging. Vehicle specific data 608 is collected, stored, and analyzed via external data sources 162 to determine trends for repeat customers that can then be utilized to provide a more personalized charging experience, while also enabling multi-day load capacity module 604 to project next visits from a given customer and a possible charging level required from said customer.

Multi-day load capacity module 604 uses date-specific adjustments 610 when determining projected load of EV chargers 120, such as by adjusting projected load in response to holidays or data-specific changes in traffic patterns that deviate from normal. Date-specific adjustments 610 are particularly important for accounting for holidays or other events that do not maintain a set date, when predicting load of EV chargers 120. System alerts 612 represent, for example, one or more aspects of health of XFC system 104, such as BESS 118 health, BESS 118 capacity, or abnormal system-level energy losses. Multi-day load capacity module 604 uses data representing health of XFC system 104, for example, to account for any health aspect of XFC system 104 that might affect predicted load of EV chargers 120.

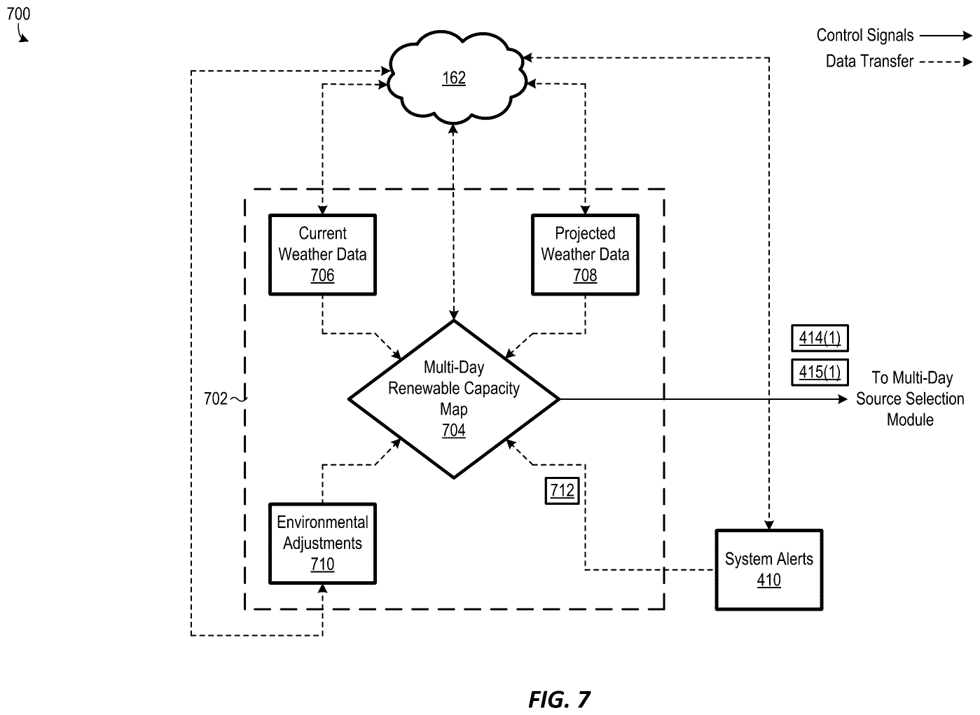

FIG. 7 is a schematic diagram 700 of control logic of a renewable projection module 702, where renewable projection module 702 is one embodiment of renewable projection module 404 of FIG. 4. Schematic diagram 700 includes system alerts module 410 and external data sources 162, in addition to renewable projection module 702. Control signal flow is indicated by a light arrow, and data transfer is indicated by dashed arrows, in schematic diagram 700. Renewable projection module 702 includes a multi-day renewable capacity module 704, current weather data 706, projected weather data 708, and environmental adjustments 710. In some embodiments, multi-day renewable capacity module 704 is implemented by processing subsystem 502 of FIG. 5 implementing renewable capacity projection instructions 510. Additionally, in some embodiments, current weather data 706, projected weather data 708, and environmental adjustments 710 are stored in storage subsystem 504.

Multi-day renewable capacity module 704 is configured to generate maps 414 and 415 from one or more of current weather data 706, projected weather data 708, environmental adjustments 710, external data sources 162, system alerts 712 from system alerts module 410, and historical capacity of renewable energy sources (e.g., historical daily average capacity of PV energy source 108 and/or other renewable energy sources 112). In particular embodiments, renewable energy sources, e.g., PV energy source 108 and other renewable energy sources 112 (when present), constitute a primary energy source for XFC system 104, with emphasis on PV energy source 108. It is believed the amortized cost of energy with an industrial scale photovoltaic system will be the most cost effective, depending upon location, compared to grid-based AC energy source 126 which may serve as a backup power source. Like all renewable energy sources, there is some variability in capacity of PV energy source 108 and other renewable energy sources 112 due to both natural and man-made conditions, so it is likely that renewable energy sources, even when sized correctly, may not have sufficient capacity to provide power to XFC system 104 based upon projected load from map 418. Some of these variables are very predictable, such as sunrise/sunset times for photovoltaic power conversion and sun angle during the day with respect to solar panels, and while other variables can be predicted with a degree of certainty, such as weather modeling using current weather data 706 and projected weather data 708. Particular embodiments of multi-day renewable capacity module 704 take these variables into account when projecting renewable energy capacity.

Additionally, some embodiments of multi-day renewable capacity module 704 consider environmental adjustments 710 when projecting renewable energy capacity. Environmental adjustments 710 include, for example, obscuration from particulate due to wild fires, dust/sand storms, etc. Some embodiments of multi-day renewable capacity module 704 also consider health of XFC system 104, such as expressed by system alerts 712, to adjust renewable energy capacity projections based on health of XFC system 104. For example, multi-day renewable capacity module 704 may reduce projected capacity of PV energy source 108 in response to system alerts 712 indicating an impairment in DC converter 132. Additional examples of possible system health expressed by system alerts 712 include, but are not limited to, (i) individual photovoltaic module health in PV array 146 (e.g., insolation, power, voltage, current, and temperature), (ii) collective health of multiple photovoltaic modules in PV array 146 (e.g., string power, string voltage, string current, and string temperature), and (iii) wind turbine parameters (e.g., speed, power, voltage, and current) in embodiments where other renewable energy sources 112 include a wind turbine.

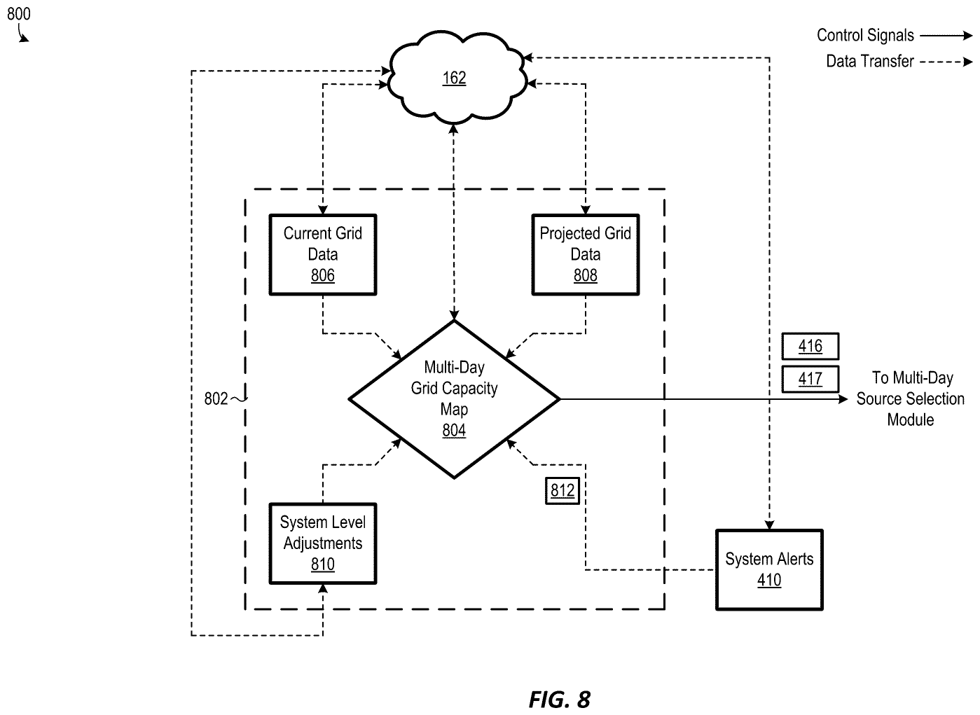

FIG. 8 is a schematic diagram 800 of control logic of a grid projection module 802, where grid projection module 802 is one embodiment of grid projection module 406 of FIG. 4. Schematic diagram 800 includes system alerts module 410 and external data sources 162, in addition to renewable projection module 802. Control signal flow is indicated by a light arrow, and data transfer is indicated by dashed arrows, in schematic diagram 800. Grid projection module 802 includes a multi-day grid capacity module 804, current grid data 806, projected grid data 808, and system level adjustments 810. In some embodiments, multi-day grid capacity module 804 is implemented by processing subsystem 502 of FIG. 5 executing grid capacity projection instructions 514 of FIG. 5. Additionally, in some embodiments, current grid data 806, projected grid data 808, and system level adjustments 810 are stored in storage subsystem 504.

Multi-day grid capacity module 804 is configured to generate maps 416 and 417 from one or more of current grid data 806, projected grid data 808, system level adjustments 810, external data sources 162, and system alerts 812 from system alerts module 410. For example, in some embodiments, multi-day grid capacity module 804 uses as inputs one or more of (i) real-time health of AC electric power grid 110 from external data sources 162, (ii) possible limitations on AC electric power grid 110 capacity from external data sources 162, (iii) voltage fluctuations from current grid data 806, (iv) grid power prices from current grid data 806, and (v) projected grid reliability over several days from projected grid data 808, to help determine a temporal landscape of AC electric power grid 110 capacity and availability. Additionally, certain embodiments of multi-day grid capacity module 804 consider system level adjustments 810 to determine if any system-level adjustments are necessary outside of normal operational parameters for AC electric power grid 110. Examples of parameters which generate system level adjustments 810 include, but are not limited to, electromagnetic interference due to sunspot activities or other potential phenomena that might affect availability of AC electric power grid 110. Some embodiments of multi-day grid capacity module 804 also consider health of XFC system 104 as expressed by system alerts 812 when determining AC electric power grid 110 capacity. For example, multi-day grid capacity module 804 may reduce projected capacity of AC electric power grid 110 in response to a problem with one or more of isolation transformer 156 and PCS 158.

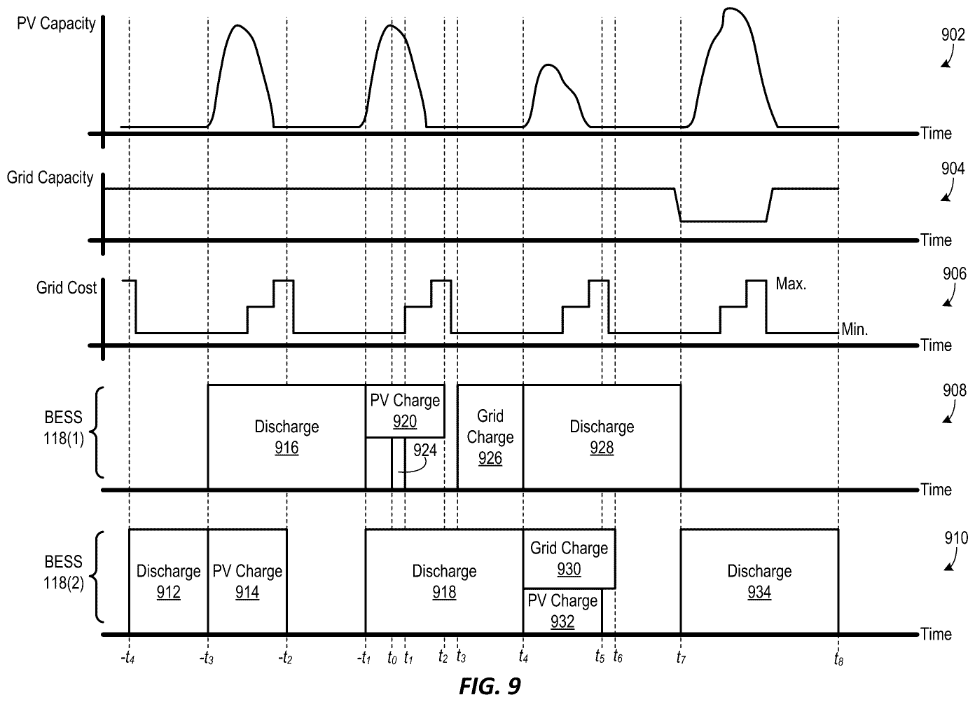

FIG. 9 illustrates one example of operation of EMS 402 of FIG. 4, although it is understood that EMS 402 could operate in other manners. FIG. 9 includes a graph 902, a graph 904, a graph 906, a timeline 908, and a timeline 910, which share a common time base. Graph 902 illustrates projected capacity of PV energy source 108 versus time, such as specified by map 414, and graph 904 represents capacity of AC electric power grid 110 as a function of time, such as specified by map 416. Graph 906 represents cost of energy purchased from AC electric power grid 110, such as specified by map 417. Timeline 908 illustrates operation of BESS 118(1) as a function of time, such as specified by one or more selection maps 422. Additionally, timeline 910 illustrates operation of BESS 118(2) as a function of time, such as specified by one or more of selection maps 422.

Time t₀ represents the present time. Accordingly, all times to right of time to are in the future, and all times to the left of time t₀ are in the past. Capacity of PV energy source 108 is projected to be relatively low between times t₄ and t₅, as illustrated in graph 902, such as due to predicted cloudy weather. Additionally, capacity of AC electric power grid 110 is projected to be abnormally low between times t₇ and t₈, as illustrated in graph 904, such as due to a predicted brownout or upcoming scheduled maintenance. Cost of energy purchased from AC electric power grid 110 varies between a minimum value (Min.) and a maximum value (Max.), such as based on demand for energy from AC electric power grid 110, as illustrated in graph 906. While graph 906 depicts three levels of cost of energy purchased from AC electric power grid 110, it is understood that cost of energy purchased from an AC electric power grid may be structured in other manners.

Between times −t₄ and −t₃, capacity of PV energy source 108 was zero. However, BESS 118(2) was substantially charged, and EMS 402 therefore selected BESS 118(2) to power EV chargers 120 by causing BESS 118(2) to operate in a discharge mode 912 between times −t₄ and −t₃, where discharge mode 912 is characterized by BESS 118(2) powering EV chargers 120. BESS 118(1) was also substantially charged at time −t₄, but EMS 402 caused BESS 118(1) to be idle between times −t₄ and −t₃ to save its capacity for later use. PV energy source 108 had significant capacity between times −t₃ and −t₂, as illustrated in graph 902. Accordingly, EMS 402 selected PV energy source 108, instead of AC electric power grid 110, for charging BESS 118(2) between times −t₃ and −t₂ because cost of energy from PV energy source 108 is less than cost of energy from AC electric power grid 110. Accordingly, BESS 118(2) operated in a PV charge mode 914 between times −t₃ and −t₂, which is characterized by BESS 118(2) being charged by PV energy source 108. Additionally, EMS 402 selected BESS 118(1) to power EV chargers 120 between times −t₃ and −t₁ by causing BESS 118(1) to operate in a discharge mode 916 during this time period, where discharge mode 916 is characterized by BESS 118(1) powering EV chargers 120. At time −t₁, EMS 402 selected BESS 118(2) to power EV chargers 120 by causing BESS 118(2) to operate in a discharge mode 918, where discharge mode 918 is characterized by BESS 118(2) powering EV chargers 120. Additionally, at time −t₁, EMS 402 selected PV energy source 108 to charge BESS 118(1) by causing BESS 118(1) to operate in a PV charge mode 920 which is characterized by PV energy source 108 charging BESS 118(1).

At time −t₁, (i) EMS 402 obtains data representing projected weather over a future time duration (e.g., several days) from external data sources 162, (ii) estimates capacity of PV energy source 108 using renewable projection module 404, (iii) determines projected load (not shown in FIG. 9) of EV chargers 120 using load projection module 408, and (iv) generates one or more selection maps 422 using multi-day source selection module 412. In this example, the one or more selection maps 422 specify selected electric energy sources for charging BESSs 118 and powering EV chargers 120 between times t₀ and t₈, as illustrated in timelines 908 and 910. In response to projected decrease in PV energy source 108 capacity between times t₄ and t₅ and projected drop in available capacity of AC electric power grid 110 between times t₇ and t₈, EMS 402 selects AC electric power grid 110 to charge BESS 118(1) by causing BESS 118(1) to operate in a grid charge mode 924 for between times t₀ and t₁, to compensate for the aforementioned decreases in capacity of PV energy source 108 and AC electric power grid 110. Grid charge mode 924 is characterized by AC electric power grid 110 charging BESS 118(1). It should be noted that EMS 402 causes BESS 118(1) to operate in grid charge mode 924 solely when cost of energy purchased from AC electric power grid 110 is low. Additionally, EMS 402 selects PV energy source 108 for charging BESS 118(1) by causing BESS 118(1) to operate in a PV charge mode 920 between times −t₁ and t₂, which is characterized by PV energy source 108 charging BESS 118(1). Furthermore, EMS 402 selects AC electric power grid 110 for charging BESS 118(1) between times t₃ and t₄ by causing BESS 118(1) to operate in a grid charge mode 926, due to (i) the upcoming decrease in capacity of AC electric power grid 110 and (ii) the relatively low cost of energy purchased from AC electric power grid 110 during this time frame. Grid charge mode 926 is characterized by BESS 118(1) being charged from AC electric power grid 110.

EMS 402 selects BESS 118(1) to power EV chargers 120 between time t₄ and t₇ by causing BESS 118(1) to operate in a discharge mode 928, which is characterized by BESS 118(1) powering EV chargers 120. Additionally, EMS 402 prepares BESS 118(2) for future use in powering EV chargers 120 by (i) selecting AC electric power grid 110 to charge BESS 118(2) between times t₄ and t₆ by causing BESS 118(2) to operate in a grid charge mode 930 and (ii) selecting PV energy source 108 to charge BESS 118(2) between times t₄ and t₅ by causing BESS 118(2) to operate in a PV charge mode 932 when PV energy source 108 is projected to have capacity. Grid charge mode 930 is characterized by BESS 118(2) being charged from AC electric power grid 110, and PV charge mode 932 is characterized by BESS 118(2) being charged by PV energy source 108. Charging BESS 118(2) between times t₄ and t₆ from AC electric power grid 110 will require purchasing energy from AC electric power grid 110 at a relatively high price, but this purchase is required due to the projected low capacity of PV energy source 108 during this time frame and the projected upcoming drop in capacity of AC electric power grid 110. Finally, EMS 402 selects BESS 118(2) to power EV chargers 120 between times t₇ and t₈ by causing BESS 118(2) to operate in a discharge mode 934, which is characterized by BESS 118(2) powering EV chargers 120.

### Control Logic

Certain embodiments of EMS 102 and EMS 402 operate according to control logic of TABLES 1-4 below. It is understood, though, that EMS 102 and EMS 402 are not limited to operating according to this control logic. The control logic of TABLES 1-4 assumes that XFC system 104 includes N charging stations, where N is a positive integer. For example, in the example of FIG. 1 where XFC system 104 includes two EV chargers 120, N is equal to two.

TABLE 1
Definitions

| | |
|---|---|
| BESS | BESSs 118 |
| SOC | State of Charge of BESSs 118 |
| C1 | Power Demand from EV Charger 120(1) |
| C2 | Power Demand from EV Charger 120(2) |
| ● | ● |
| ● | ● |
| ● | ● |
| CN | Power Demand from EV Charger 120(N) |
| TP | Summation of C1, C2, . . . CN |
| PS | Aggregate Source of Power to XFC System 104 |
| PV | Source of Power from PV Energy Source 108 |
| BS | Source of Power from BESSs 118 |
| CG | Source of Power from AC Electric Power Grid 110 |

TABLE 2
EMS Priorities

| | |
|---|---|
| 1 | To monitor, manage, and ensure uninterrupted |
| | dispensing of TP at any one point, i.e., |
| | PS must always be greater than or equal to TP. |
| 2 | To deliver PS based on the following |
| | priority: (1) PV, (2) BESS, and (3) CG. |
| 3 | To monitor the PV system and the SOC of the BESS. |
| 4 | To monitor and record the total electricity |
| | dispensed between PC & CG during the |
| | three monitoring periods discussed below in TABLE 4. |

TABLE 3
PS Control Logic

| | |
|---|---|
| 1 | If the sum of C1:CN is < PV, then PS = PV. |
| 2 | If the sum of C1:CN is > PV, then PS = PV + BS, |
| | where BS = PS − max of PV. |
| 3 | If TP = 0 or is < PS, then all excess PV shall recharge BESS. |
| 4 | If PV = 0, then TP = PS = BS. |
| 5 | If PV = 0 and TP > BS, then PS = CG. |
| | (Note: this scenario should not occur under |
| | normal operating circumstances and is a last |
| | resort of power source.) |

TABLE 4
BESS Recharging Logic

| | |
|---|---|
| 1 | From 07:00H to 17:00H, if SOC <40%, the |
| | BESS shall be recharged by CG until |
| | 80%. |
| 2 | From 17:00H to 21:00H, CG shall only be |
| | on standby mode unless BESS <10%. |
| 3 | From 21:00H to 07:00H, CG shall |
| | continuously recharge BESS until 100%. |

### Additional Embodiments

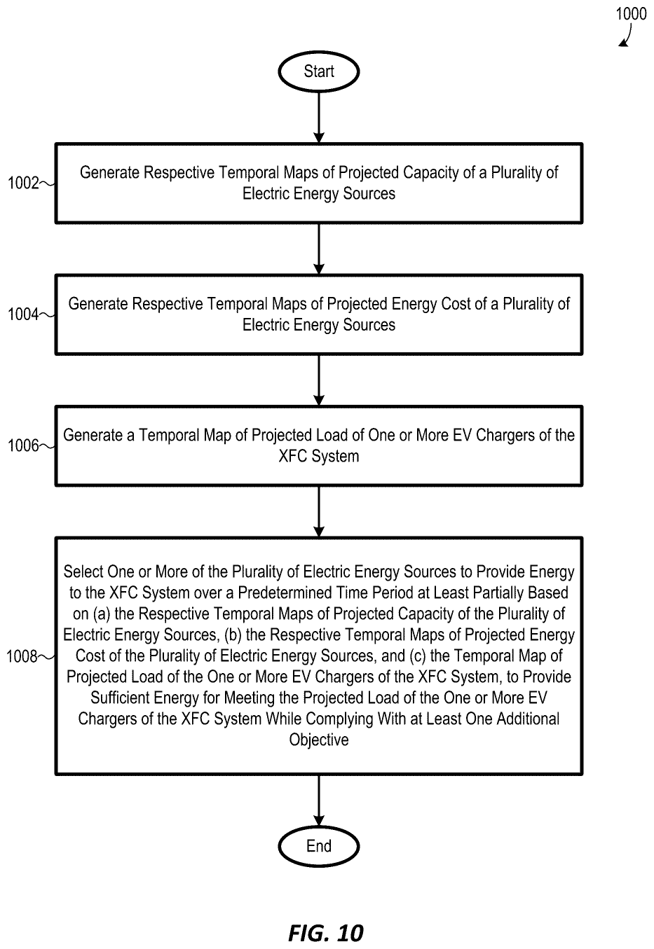

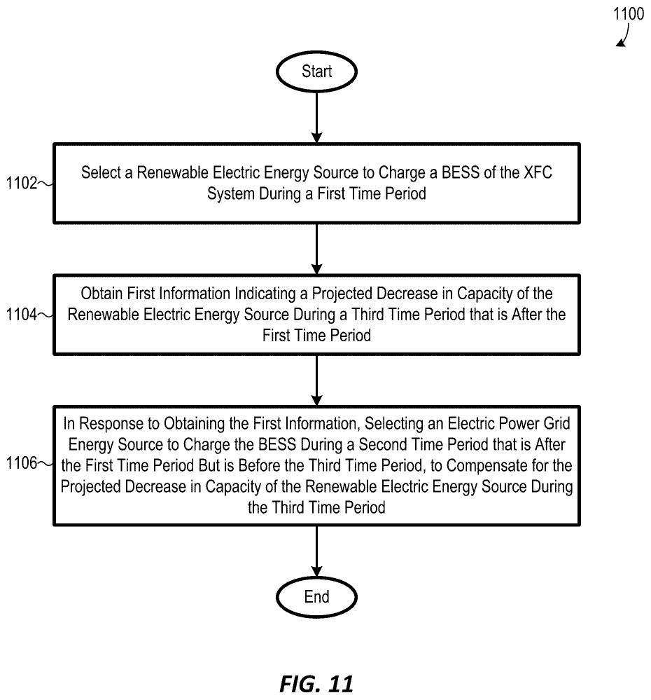

FIGS. 10 and 11, discussed below, illustrate several additional examples of operation of EMS 102 and EMS 402. It is understood, though, that EMS 102 and EMS 402 are not limited to operating according to the examples of FIGS. 10 and 11.

FIG. 10 is a flow chart of a method 1000 operable by an EMS for operating an XFC system. In a block 1002 of method 1000, respective temporal maps of projected capacity of a plurality of electric energy sources are generated. In one example of block 1002, renewable projection module 404 generates map 414(1), and grid projection module 406 generates map 416. In a block 1004 of method 1000, respective temporal maps of projected energy cost of the plurality of electric energy sources are generated. In one example of block 1004, renewable projection module 404 generates map 415(1), and grid projection module 406 generates map 417. In a block 1006 of method 1000, a temporal map of projected load of one or more EV chargers of the XFC system is generated. In one example of block 1006, load projection module 408 generates map 418.

In a block 1008 of method 1000, one or more of the plurality of electric energy sources are selected to provide energy to the XFC system over a predetermined time period at least partially based on (a) the respective temporal maps of projected capacity of the plurality of electric energy sources, (b) the respective temporal maps of projected energy cost of the plurality of electric energy sources, and (c) the temporal map of projected load of the one or more EV chargers of the extreme fast-charging system, to provide sufficient energy for meeting the projected load of the one or more EV chargers of the XFC system while complying with at least one additional objective. In one example of block 1008, multi-day source selection module 412 generates one or more maps 422 specifying the selection of electric energy sources illustrated in timelines 908 and 910 of FIG. 9, to achieve lowest cost of powering EV chargers 120 and ensuring sufficient energy to meet projected load of EV chargers 120.

FIG. 11 is a flow chart of a method 1100 operable by an EMS for operating an XFC system. In a block 1102 of method 1100, a renewable electric energy source is selected to charge a BESS of the XFC system during a first time period. In one example of block 1102, EMS 402 selects PV energy source 108 to charge BESS 118(1) between times −t₁ and t₂, as illustrated in FIG. 9. In a block 1104 of method 1100, the EMS obtains first information indicating a projected decrease in capacity of the renewable electric energy source during a third time period that is after the first time period. In one example of block 1104, EMS 402 obtains from external data sources 162 information indicating the projected decrease in capacity of AC electric power grid 110 between times t₇ and t₈, as illustrated in FIG. 9. In a block 1106 of method 1100, in response to obtaining the first information, the EMS selects an electric power grid energy source to charge the

BESS during a second time period that is after the first time period but is before the third time period, to compensate for the projected decrease in capacity of the renewable electric energy source during the third time period. In one example of block 1106, EMS 402 selects AC electric power grid 110 to charge BESS 118(1) between times t₃ and t₄, in response to receiving the information indicating the projected decrease in capacity of AC electric power grid 110 between times t₇ and t₈.

### Combinations of Features

Features described above may be combined in various ways without departing from the scope hereof. The following examples illustrate some possible combinations.
(A1) A method operable by an EMS for operating XFC system includes (1) generating respective temporal maps of projected capacity of a plurality of electric energy sources, (2) generating respective temporal maps of projected energy cost of the plurality of electric energy sources, (3) generating a temporal map of projected load of one or more electric vehicle chargers of the extreme fast-charging system, and (4) selecting one or more of the plurality of electric energy sources to provide energy to the extreme fast-charging system over a predetermined time period at least partially based on (a) the respective temporal maps of projected capacity of the plurality of electric energy sources, (b) the respective temporal maps of projected energy cost of the plurality of electric energy sources, and (c) the temporal map of projected load of the one or more electric vehicle chargers of the extreme fast-charging system, to provide sufficient energy for meeting the projected load of the one or more electric vehicle chargers of the extreme fast-charging system while complying with at least one additional objective.
(A2) In the method denoted as (A1), the at least one additional objective may include minimizing cost of energy for meeting the projected load of the one or more electric vehicle chargers of the extreme fast-charging system.
(A3) In either one of the methods denoted as (A1) and (A2), the at least one additional objective may include prioritizing a first electric energy source of the plurality of electric energy sources over a second electric energy source of the plurality of electric energy sources.
(A4) In the method denoted as (A3), (1) the first electric energy source may be a renewable electric energy source, and (2) the second electric energy source may be a non-renewable electric energy source.
(A5) In any one of the methods denoted as (A1) through (A4), generating the temporal map of projected load of the one or more electric vehicle chargers of the extreme fast-charging system may include obtaining data representing historical use of energy by the extreme fast-charging system from a data source accessible to the EMS.
(A6) In any one of the methods denoted as (A1) through (A5), generating the temporal map of projected load of the one or more electric vehicle chargers of the extreme fast-charging system may include obtaining data associated with customers of the extreme fast-charging system from a data source accessible to the EMS.
(A7) In any one of the methods denoted as (A1) through (A6), generating the temporal map of projected load of the one or more electric vehicle chargers of the extreme fast-charging system may include obtaining data representing holidays at a location of the extreme fast-charging system from a data source accessible to the EMS.
(A8) In any one of the methods denoted as (A1) through (A7), generating the temporal map of projected load of the one or more electric vehicle chargers of the extreme fast-charging system may include obtaining data representing traffic patterns in a vicinity of the extreme fast-charging system from a data source accessible to the EMS.
(A9) Any one of the methods denoted as (A1) through (A8) may further include controlling charging of one or more BESSs of the extreme fast-charging system from energy provided to the extreme fast-charging system.
(A10) Any one of the methods denoted as (A1) through (A9) may further include simultaneously (a) charging a first BESS of the extreme fast-charging system from energy provided to the extreme fast-charging system and (b) discharging a second BESS of the extreme fast-charging system at least partially for powering the one or more electric vehicle chargers of the extreme fast-charging system.
(A11) In any one of the methods denoted as (A1) through (A10), the EMS may be configured to select one or more of the plurality of electric energy sources to provide energy to the extreme fast-charging system further based on health of the extreme fast-charging system.
(A12) In any one of the methods denoted as (A1) through (A11), the plurality of electric energy sources may include (a) a renewable electric energy source and (b) an electric power grid energy source.
(A13) In any one of the methods denoted as (A1) through (A12), (1) the plurality of electric energy sources may include a photovoltaic energy source and (2) generating respective temporal maps of projected capacity of the plurality of electric energy sources may include generating a temporal map including projected capacity of the photovoltaic energy source at least partially based on one or more actual or predicted environmental conditions at a location of the photovoltaic energy source.
(A14) In any one of the methods denoted as (A1) through (A13), (1) the plurality of electric energy sources may include an electric power grid energy source and (2) generating respective temporal maps of projected capacity of the plurality of electric energy sources may include generating a temporal map including projected capacity of the electric power grid energy source at least partially based on a projected reliability of the electric power grid energy source.
(A15) In any one of the methods denoted as (A1) through (A14), (1) the plurality of electric energy sources may include a renewable electric energy source and an electric power grid energy source and (2) selecting the one or more of the plurality of electric energy sources to provide energy to the extreme fast-charging system over the predetermined time period may include generating a first control signal causing a first switching device to be closed between a first time and a second time, the first switching device electrically coupling the renewable electric energy source to a BESS of the extreme fast-charging system.
(A16) In the method denoted as (A15), selecting the one or more of the plurality of electric energy sources to provide energy to the extreme fast-charging system over the predetermined time period may further include generating a second control signal causing a second switching device to be closed between the second time and a third time, the second switching device electrically coupling the electric power grid energy source to the BESS of the extreme fast-charging system.
(B1) A method operable by an EMS for operating an XFC system includes (1) selecting a renewable electric energy source to charge a BESS of the extreme fast-charging system during a first time period, (2) obtaining first information indicating a projected decrease in capacity of the renewable electric energy source during a third time period that is after the first time period, and (3) in response to obtaining the first information, selecting an electric power grid energy source to charge the BESS during a second time period that is after the first time period but is before the third time period, to compensate for the projected decrease in capacity of the renewable electric energy source during the third time period.
(B2) The method denoted as (B1) may further include selecting the second time period to correspond to a time period when cost of energy purchased from the electric power grid energy source is at a minimum value.
(B3) Either one of the methods denoted as (B1) and (B2) may further include powering one or more electric vehicle (EV) chargers from the BESS.
(B4) In any one of the methods denoted as (B1) through (B3), (1) selecting the renewable electric energy source to charge the BESS during the first time period may include generating a first control signal causing a first switching device to be closed during the first time period, the first switching device electrically coupling the renewable electric energy source to the BESS, and (2) selecting the electric power grid energy source to charge the BESS during the second time period may include generating a second control signal causing a second switching device to be closed during the second time period, the second switching device electrically coupling the electric power grid energy source to the BESS.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A method operable by an energy management system (EMS) for operating an extreme fast-charging system, the method comprising:
generating respective temporal maps of projected capacity of a plurality of electric energy sources;
generating respective temporal maps of projected energy cost of the plurality of electric energy sources;
generating a temporal map of projected load of one or more electric vehicle chargers of the extreme fast-charging system; and
selecting one or more of the plurality of electric energy sources to provide energy to the extreme fast-charging system over a predetermined time period at least partially based on (a) the respective temporal maps of projected capacity of the plurality of electric energy sources, (b) the respective temporal maps of projected energy cost of the plurality of electric energy sources, and (c) the temporal map of projected load of the one or more electric vehicle chargers of the extreme fast-charging system, to provide sufficient energy for meeting the projected load of the one or more electric vehicle chargers of the extreme fast-charging system while complying with at least one additional objective.

2. The method of claim 1, wherein the at least one additional objective comprises minimizing cost of energy for meeting the projected load of the one or more electric vehicle chargers of the extreme fast-charging system.

3. The method of claim 1, wherein the at least one additional objective comprises prioritizing a first electric energy source of the plurality of electric energy sources over a second electric energy source of the plurality of electric energy sources.

4. The method of claim 3, wherein:
the first electric energy source is a renewable electric energy source; and
the second electric energy source is a non-renewable electric energy source.

5. The method of claim 1, wherein generating the temporal map of projected load of the one or more electric vehicle chargers of the extreme fast-charging system comprises obtaining data representing historical use of energy by the extreme fast-charging system from a data source accessible to the EMS.

6. The method of claim 1, wherein generating the temporal map of projected load of the one or more electric vehicle chargers of the extreme fast-charging system comprises obtaining data associated with customers of the extreme fast-charging system from a data source accessible to the EMS.

7. The method of claim 1, wherein generating the temporal map of projected load of the one or more electric vehicle chargers of the extreme fast-charging system comprises obtaining data representing holidays at a location of the extreme fast-charging system from a data source accessible to the EMS.

8. The method of claim 1, wherein generating the temporal map of projected load of the one or more electric vehicle chargers of the extreme fast-charging system comprises obtaining data representing traffic patterns in a vicinity of the extreme fast-charging system from a data source accessible to the EMS.

9. The method of claim 1, further comprising controlling charging of one or more battery energy storage systems (BESSs) of the extreme fast-charging system from energy provided to the extreme fast-charging system.

10. The method of claim 1, further comprising simultaneously (a) charging a first battery energy storage system (BESS) of the extreme fast-charging system from energy provided to the extreme fast-charging system and (b) discharging a second BESS of the extreme fast-charging system at least partially for powering the one or more electric vehicle chargers of the extreme fast-charging system.

11. The method of claim 1, wherein the EMS is configured to select one or more of the plurality of electric energy sources to provide energy to the extreme fast-charging system further based on health of the extreme fast-charging system.

12. The method of claim 1, wherein the plurality of electric energy sources comprises (a) a renewable electric energy source and (b) an electric power grid energy source.

13. The method of claim 1, wherein:
the plurality of electric energy sources comprises a photovoltaic energy source; and
generating respective temporal maps of projected capacity of the plurality of electric energy sources comprises generating a temporal map including projected capacity of the photovoltaic energy source at least partially based on one or more actual or predicted environmental conditions at a location of the photovoltaic energy source.

14. The method of claim 1, wherein:
the plurality of electric energy sources comprises an electric power grid energy source; and
generating respective temporal maps of projected capacity of the plurality of electric energy sources comprises generating a temporal map including projected capacity of the electric power grid energy source at least partially based on a projected reliability of the electric power grid energy source.

15. The method of claim 1, wherein:
the plurality of electric energy sources comprise a renewable electric energy source and an electric power grid energy source; and
selecting the one or more of the plurality of electric energy sources to provide energy to the extreme fast-charging system over the predetermined time period comprises generating a first control signal causing a first switching device to be closed between a first time and a second time, the first switching device electrically coupling the renewable electric energy source to a battery energy storage system (BESS) of the extreme fast-charging system.

16. The method of claim 15, wherein selecting the one or more of the plurality of electric energy sources to provide energy to the extreme fast-charging system over the predetermined time period further comprises generating a second control signal causing a second switching device to be closed between the second time and a third time, the second switching device electrically coupling the electric power grid energy source to the BESS of the extreme fast-charging system.

17. A method operable by an energy management system (EMS) for operating an extreme fast-charging system, the method comprising:
selecting a renewable electric energy source to charge a battery energy storage system (BESS) of the extreme fast-charging system during a first time period;
obtaining first information indicating a projected decrease in capacity of the renewable electric energy source during a third time period that is after the first time period; and
in response to obtaining the first information, selecting an electric power grid energy source to charge the BESS during a second time period that is after the first time period but is before the third time period, to compensate for the projected decrease in capacity of the renewable electric energy source during the third time period.

18. The method of claim 17, further comprising selecting the second time period to correspond to a time period when cost of energy purchased from the electric power grid energy source is at a minimum value.

19. The method of claim 17, further comprising powering one or more electric vehicle (EV) chargers from the BESS.

20. The method of claim 17, wherein:
selecting the renewable electric energy source to charge the BESS during the first time period comprises generating a first control signal causing a first switching device to be closed during the first time period, the first switching device electrically coupling the renewable electric energy source to the BESS; and
selecting the electric power grid energy source to charge the BESS during the second time period comprises generating a second control signal causing a second switching device to be closed during the second time period, the second switching device electrically coupling the electric power grid energy source to the BESS.
